(19) United States
(12) Patent Application Publication
(10) Pub. No.: US 2007/0296981 A1
(43) Pub. Date: Dec. 27, 2007

(54) Method of providing print preview of print document

(75) Inventors: Hee-ran Lee, Seoul (KR); Kang-hoon Lee, Yonin-si (KR); Gyong-ock Kim, Suwon-si (KR); Joo-young Jung, Seoul (KR); Duk-yong Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/654,609

(22) Filed: Jan. 18, 2007

(30) Foreign Application Priority Data
Jun. 21, 2006 (KR) 10-2006-0055910

(51) Int. Cl. G06F 3/12

(52) U.S. Cl. 358/1.1

(57) ABSTRACT

A method of providing a print preview of a print document allows a user to preview the print document on a user interface (or a registration window) of a printer driver, thereby allowing the user to intuitively recognize a print preview function and execute the print preview function without being confused by menus associated with the print preview function. The method includes selecting a print menu in an application program related to the print document to print the print document. A printer driver is executed to display a print window on a screen of a computer executing the application program when the print menu is selected on the application program. An additional print preview selection message window is displayed on the screen to instruct a user to select whether or not to invoke a print preview window when a confirmation button is pressed in the print window to transmit a print command to a printer. The print preview of the print document is displayed on the screen when the user invokes the print preview window in the print preview selection message window.

### CROSS-REFERENCE TO RELATED PATENT APPLICATION

This application claims the benefit under 35 U.S.C. §119(a) of Korean Patent Application No. 10-2006-0055910, filed on Jun. 21, 2006, in the Korean Intellectual Property Office, the entire disclosure of which is hereby incorporated by reference.

### BACKGROUND OF THE INVENTION

1. Field of the Invention:

The present invention relates to a method of providing a print preview of a print document. More particularly, the present invention relates to a method of providing a print preview of a print document that allows a user to preview the print document on a user interface (or a registration window) of a printer driver, thereby allowing the user to intuitively recognize a print preview function and execute the print preview function without being confused by menus for the print preview function.

2. Description of the Related Art:

As is well known in the art, quality or properties of a document printed by a printer may be changed in a data conversion process, such as an image processing algorithm or a color conversion technology, used in a printer driver. Therefore, to provide an exact print preview of a print document (for example, a document or an image) to the user, it is necessary to provide preview data when generating print data via the printer driver. However, since the print preview function supported by the printer driver is available only after an application program (for example, a word processor) starts to output a print command, it is difficult for the user to select, use or disable the print preview function, and moreover, the print preview function may be an inconvenient function for a user who does not want to see the print preview.

Hereinafter, a conventional method of providing a print preview having the above problems will be described in detail.

FIG. 1 is a diagram for illustrating a conventional method of providing a print preview of a print document. According to the conventional method, a user executes a document editing application program or an image editing application program, such as a word processor or Photoshop (Registered Trademark), and performs a document editing task or an image editing task. When the user wants to start printing while performing the task using the application program, the user selects (or clicks) a ‘Print’ menu in the application program. Upon selecting the ‘Print’ menu in the application program, a print window is displayed on a screen.

When the user wants to utilize a print preview function in a state where the print window is displayed on the screen, the user presses (or clicks) an ‘Attribute’ button on the print window. Upon pressing the ‘Attribute’ button on the print window, a printer driver registration information window, as shown in FIG. 1, is displayed on the screen. Then, the user sets a paper size, a layout, and the like in the registration information window and selects a preview menu as indicated by an ‘Enable preview’ box to utilize the print preview function. The user completes this task by setting the printer driver registration information after selecting (checking in) the ‘Enable preview’ menu (box) and closes the registration information window by pressing an ‘OK’ button in the registration information window.

When the user presses an ‘OK’ button on the print window after closing the registration information window, a ‘preview’ window as shown in FIG. 1 is displayed on the screen while a document is being printed because the ‘Enable preview’ menu was selected.

On the other hand, when the user wants to print the document without enabling the print preview function, the user cancels the checking of the ‘Enable preview’ menu that was checked (such as by unchecking the ‘Enable preview’ box). Upon pressing the ‘OK’ button on the print window after canceling the checking of the ‘Enable preview’ menu, the document is printed with no preview image displayed on the screen.

As is obvious from the above-mentioned description, because the printer driver cannot recognize specific output data until the application program requests output data and such output data is transmitted to the printer driver, it is difficult to provide a preview image on a user interface screen of the printer driver, that is, on the printer driver registration information window. Therefore, according to the known printer driver, when a user executes a ‘Print’ function in an application program to print a document, the printer driver displays data received from the application program on a preview window and transfers the data to a printer upon receiving a confirmation signal from the user, thereby printing the document. In such a method, every time output is printed, an unnecessary preview window is displayed to a user who does not want to see the preview window so that the output time for printing is delayed. Additionally, in the method of providing a print preview overcoming the above-mentioned problems, which provides a print preview function only when a user has selected to use the print preview function on a user interface screen of a printer driver, it is difficult for the user to intuitively recognize the print preview function. Though the user has selected to use the print preview function on the user interface screen of the printer driver, because the user needs to execute a print function in an application program, the printing process becomes complicated. This may cause a user to be unwilling to use the preview function supported by the printer driver compared to the print preview function supported by the application program, in which when a print preview button is selected a preview window is displayed on the screen so as to display an output image on the preview window.

Accordingly, a need exists for a simplified method of providing a print preview function for a document to be printed.

### SUMMARY OF THE INVENTION

The present invention provides a method of providing a print preview of a print document that allows a user to preview the print document on a user interface (or a registration window) of a printer driver, thereby allowing the user to intuitively recognize a print preview function and to execute the print preview function without being confused by menus for the print preview function.

According to an aspect of the present invention, a method of providing a print preview of a print document includes selecting a print menu in an application program related to the print document to print the print document, and executing a printer driver to display a print window on a screen of a computer executing the application program when the print menu is selected on the application program. An additional print preview selection message window is displayed on the screen to instruct a user to select whether or not to invoke a print preview window when a confirmation button is pressed on the print window to transmit a print command to a printer. The print preview of the print document is displayed on the screen when the user invokes the print preview window in the print preview selection message window.

According to another aspect of the present invention, a method of providing a print preview of a print document includes selecting a print menu in an application program related to the print document to print the print document, and executing a printer driver to display a print window on a screen of a computer executing the application program when the print menu is selected on the application program. A registration information window is displayed having a print preview button for directly invoking a print preview window on the screen when an attribute button is pressed on the print window to modify a print attribute. The print preview of the print document is displayed on the screen when the user pressed the print preview button on the registration information window.

According to still another aspect of the present invention, a system for providing a print preview of a print document includes a message window control module displaying an additional print preview selection message window on a screen to instruct a user to select whether or not to invoke a print preview window when a print menu is selected in an application program related to the print document. A printer driver displays a print window on a screen of a computer, and the user presses a print confirmation button on the print window. A print preview control module displays the print preview of the print document on the screen when the user invokes the print preview window in the print preview selection message window.

According to still another aspect of the present invention, a system for providing a print preview of a print document includes a print preview control module directly invoking a print preview window when a print menu is selected in an application program related to the print document. A printer driver displays the print window on a computer screen. A user presses an attribute button on the print window to modify a print attribute, and the user presses a print preview button included in a registration information window of the printer driver. An automatic selection module automatically selects a confirmation button to transmit a print command to a printer, thereby directly invoking the print preview window, when the print preview button included in the registration information window is pressed.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a diagram for illustrating a conventional method of providing a print preview of a print document;

FIG. 2 is a flowchart illustrating a method of providing a print preview of a print document according to an exemplary embodiment of the present invention;

FIG. 3 is a schematic block diagram illustrating a system for providing a print preview of a print document according to an exemplary embodiment of the present invention;

FIGS. 4A to 4C are diagrams for explaining the method of providing a print preview of a print document illustrated in FIG. 2, according to an exemplary embodiment of the present invention;

FIG. 5 is a flowchart illustrating a method of providing a print preview of a print document according to another exemplary embodiment of the present invention;

FIGS. 6A to 6C are flowcharts illustrating operations in the method of providing a print preview of a print document illustrated in FIG. 5, according to an exemplary embodiment of the present invention;

FIG. 7 is a schematic block diagram illustrating a construction of a system for providing a print preview of a print document according to another exemplary embodiment of the present invention; and

FIG. 8 is a diagram explaining the method illustrated in FIG. 5, according to an exemplary embodiment of the present invention.

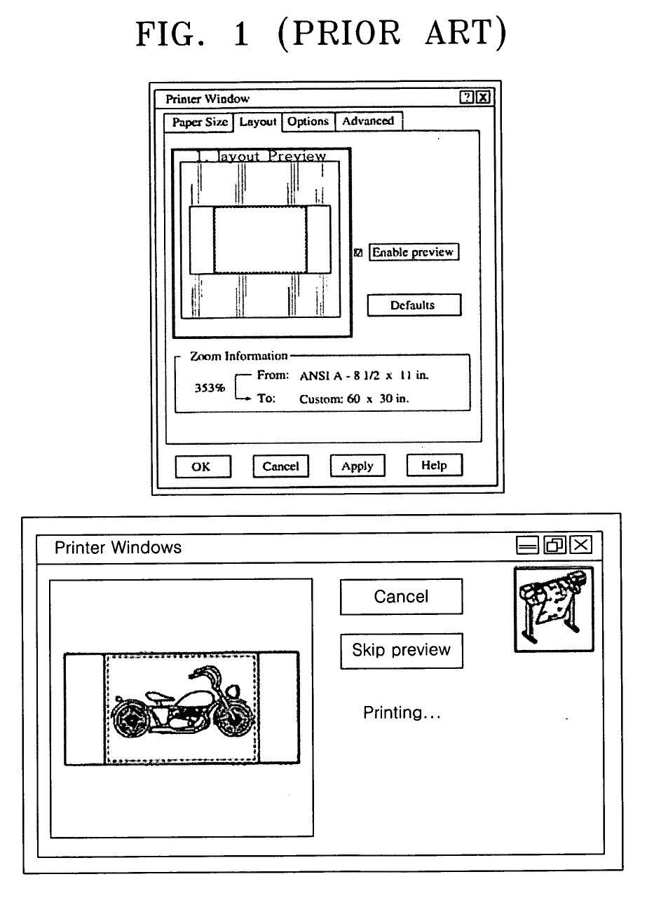

Throughout the drawings, like reference numerals will be understood to refer to like parts, components and structures.

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art.

Hereinafter, the present invention will be described in detail with reference to the attached drawings.

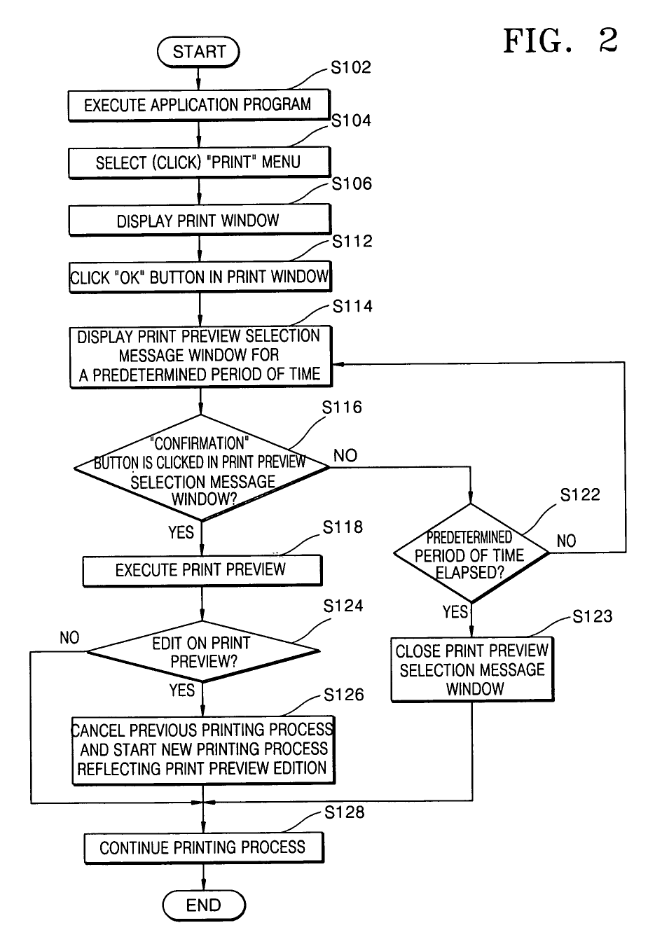

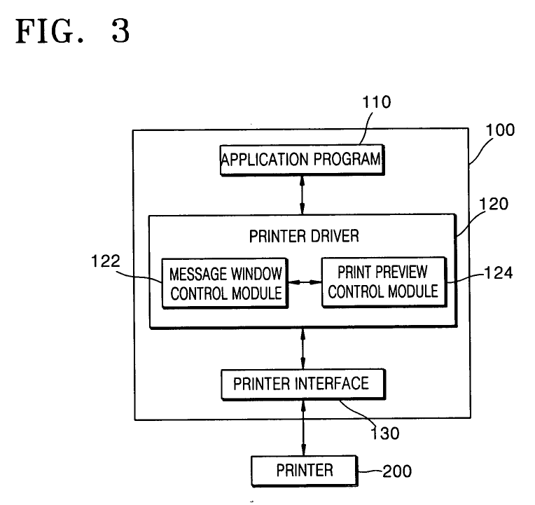

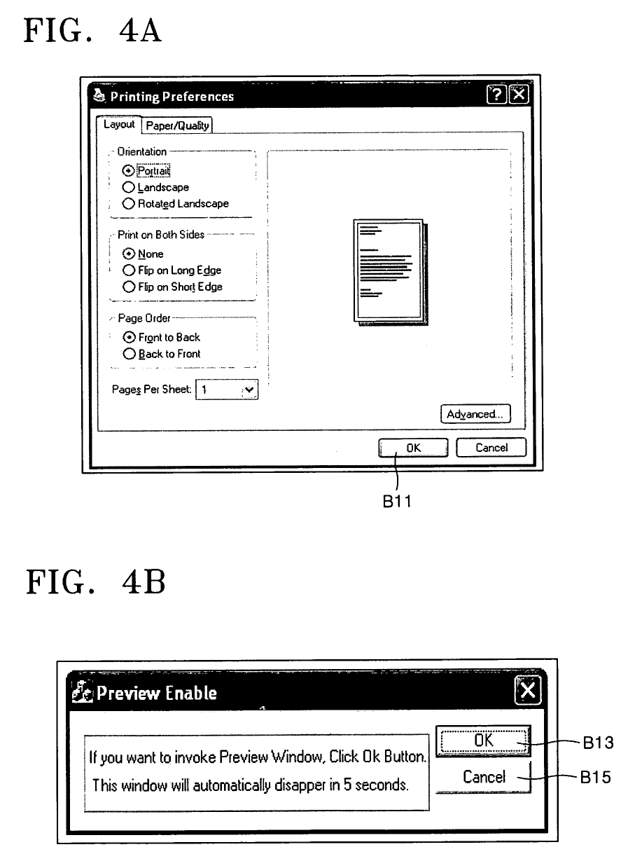

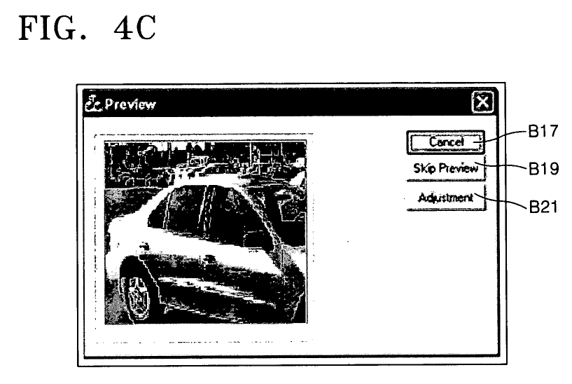

FIG. 2 is a flowchart illustrating a method of providing a print preview of a print document according to an exemplary embodiment of the present invention. FIG. 3 is a schematic block diagram illustrating a construction of a system for providing a print preview of a print document according to an exemplary embodiment of the present invention. FIGS. 4A to 4C are diagrams for explaining the method of providing a print preview of a print document illustrated in FIG. 2 according to an exemplary embodiment of the present invention.

Referring to FIGS. 2 and 3, the method of providing a print preview of a print document according to an exemplary embodiment of the present invention includes executing an application program 110 related to the print document (S102), selecting (or clicking) a print menu in the application program 110 to print the print document (S104), and executing a printer driver 120 to display a print window as shown in FIG. 4A on a screen of a computer 100 executing the application program 110 when the print menu is selected in the application program 110 (S106). A confirmation button B11 is pressed (or clicked) on the print window as illustrated in FIG. 4A to transmit a print command to a printer 200 (S112). An additional print preview selection message window, as shown in FIG. 4B, is displayed for a predetermined time period (for example, for 5 seconds) on the screen to instruct a user to select whether or not to invoke a print preview window (S114), and when the user invokes the print preview window in the print preview selection message window (for example, by clicking an OK button B13 in FIG. 4B) (S116). The print preview of the print document on the screen is displayed as illustrated in FIG. 4C (S118) when the print preview window is selected.

When the user wants to edit the print preview in operation S118 while the print preview is being displayed on the screen, the user may edit the print preview by clicking an adjustment button B21 as illustrated in FIG. 4C (S124). If the print preview is edited in operation S124, a previous printing process performed by the printer driver 120 between operations S112 and S124 is cancelled and a new printing process reflecting the edition is started (S126). If the print preview is not edited in operation S124, the printing process performed by the printer driver 120 between operations S112 and the S124 is continued (S128).

A skip button B19 for skipping the print preview and a cancel button B17 for canceling the print job of the print document are included in the print preview window.

The print preview selection message window is displayed until the user selects the confirmation button B13, the cancel button B15 or the predetermined time period elapses (S122). If a confirmation button B13 in the print preview selection message window is not clicked for a predetermined time period (for example, for 5 seconds) in operation S116, the print preview selection message window automatically disappears (S123). Additionally, when a cancel button B15 included in the print preview selection message window is clicked in the predetermined time period, the print preview selection message window disappears. The predetermined time period for which the print preview selection message is displayed on the computer screen may be the time taken for all of the print spool data processed by the printer driver 120 to be transmitted to the printer 200.

Referring to FIG. 3, the system for providing a print preview of a print document according to an exemplary embodiment of the present invention includes a message window control module 122 displaying an additional print preview selection message window as illustrated in FIG. 4B on a screen to instruct a user to select whether or not to invoke a print preview window when a print menu is selected in an application program 110 related to the print document. A printer driver 120 displays a print window as illustrated in FIG. 4A on a screen of a computer 100, and the user presses a print confirmation button B11 on the print window. A print preview control module 124 displays the print preview of the print document on the screen of the computer 100 when the user invokes the print preview window in the print preview selection message window (for example, by clicking an OK button B13). In FIG. 3, reference numeral 130 indicates an interface for connecting the computer 100 and the printer 200.

The message window control module 122 displays the print preview selection message window on the screen of the computer 100 only for a predetermined time period. On the print preview window of the print document, the print preview control module 124 displays a skip button B19 for skipping the print preview, a cancel button B17 for canceling the print job of the print document, and a print adjustment button B21 for adjusting print values for the print document.

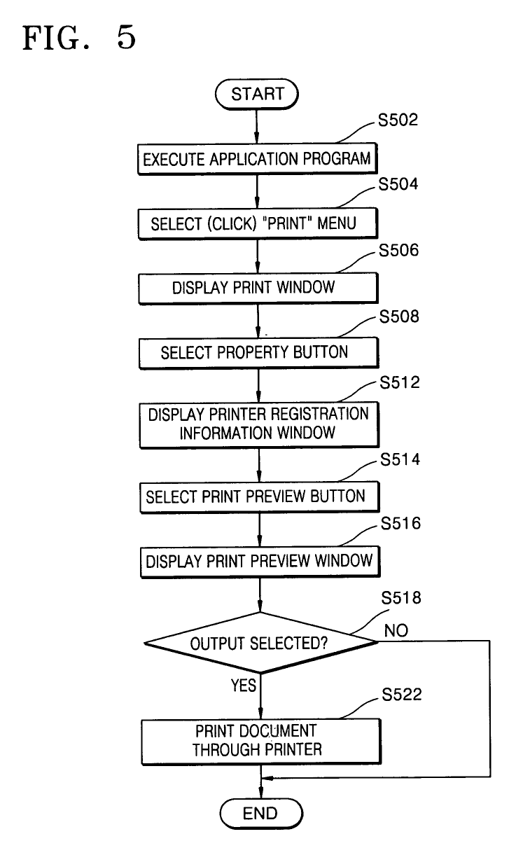

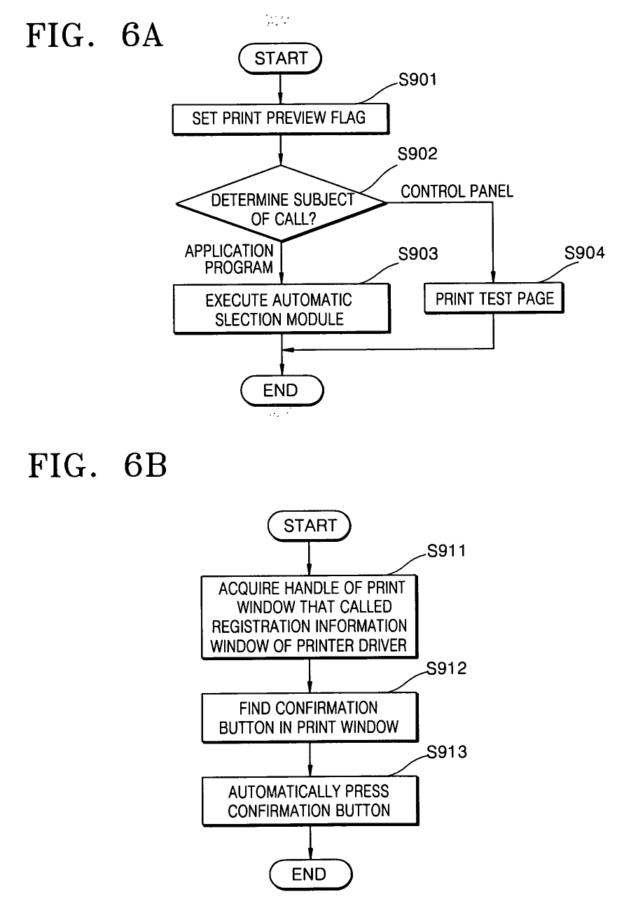

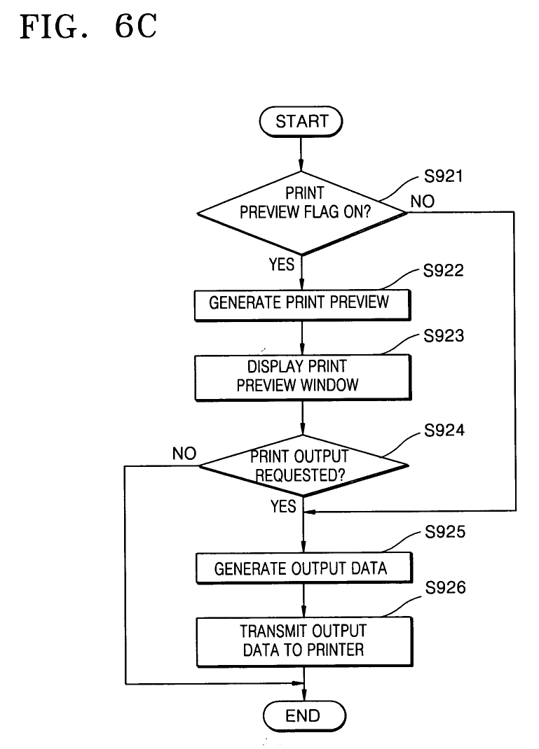

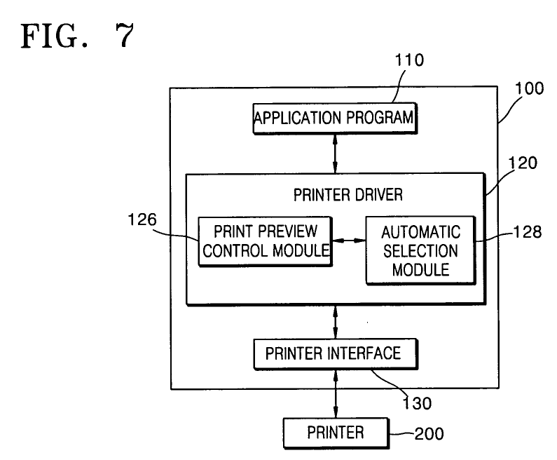

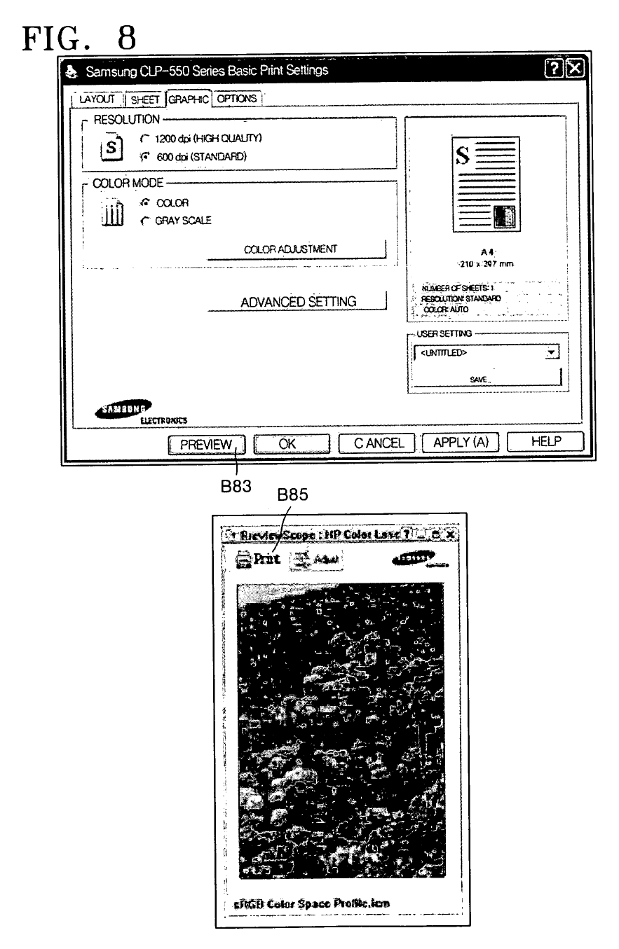

FIG. 5 is a flowchart illustrating a method of providing a print preview of a print document according to another exemplary embodiment of the present invention. FIGS. 6A to 6C are flowcharts illustrating operations in the method illustrated in FIG. 5 according to exemplary embodiments of the present invention. FIG. 7 is a schematic block diagram illustrating a construction of a system for providing a print preview of a print document according to another exemplary embodiment of the present invention. FIG. 8 is a diagram for explaining the method illustrated in FIG. 5 according to an exemplary embodiment of the present invention.

Referring to FIGS. 5 and 7, the method of providing a print preview of a print document according to an exemplary embodiment of the present invention includes executing an application program 110 related to the print document (S502), and selecting (or clicking) a print menu in the application program 110 to print the print document (S504). A printer driver 120 is executed to display a print window as illustrated in FIG. 8 on a screen of a computer 100 executing the application program 110 when the print menu is selected on the application program 110 (S506). When an attribute button is pressed (or clicked) on the print window to modify a print attribute (S508), a registration information window as illustrated in FIG. 8 is displayed having a print preview button B83 for directly invoking a print preview window on the screen (S512). When the print preview button B83 is clicked on the registration information window (S514), the print preview of the print document is displayed on the screen as illustrated in FIG. 8 (S516). When the user clicks a print button B85 in the print preview window to print the print document, a printer 200 prints the print document (S518 and S522). An interface 130 connects the computer 100 and the printer 200.

Referring to FIG. 7, the system for providing a print preview of a print document according to an exemplary embodiment of the present invention includes a print preview control module 126 directly invoking a print preview window when a print menu is selected in an application program 110 related to the print document. A printer driver 120 displays the print window on a computer screen when a user presses an attribute button in the print window to modify a print attribute and the user presses a print preview button B83 included in a registration information window of the printer driver 120 as illustrated in FIG. 8. An automatic selection module 128 automatically selects a confirmation button to transmit a print command to a printer 200, thereby directly invoking the print preview window, when the print preview button B83 included in the registration information window is pressed.

Referring to FIG. 6A, when the print preview button B83 included in the registration information window illustrated in FIG. 8 is selected, the user interface of the printer driver 120 sets a print preview flag (S901) and determines whether the registration information window of FIG. 8 is invoked by the application program or a control panel (S902). When the registration information window is invoked by the application program, print data of the application program is automatically printed (S903), whereas when the registration information window is invoked by the control panel, a test page is printed (S904).

Referring to FIG. 6B, when the registration information window is invoked by the application program, the automatic selection module 128 acquires a handle of the print window that has invoked the registration information window (S911) and finds a confirmation button in the print window, thereby automatically pressing the confirmation button (S912 and S913). The automatic selection module 128 may output a message to indicate that the confirmation button is automatically pressed in the print window. When the confirmation button is automatically selected in the print window by the automatic selection module 128, a print command is transmitted to the printer 200 similar to when the user manually presses the confirmation button.

Referring to FIG. 6C, when the confirmation button is automatically selected in the print window by the automatic selection module 128, the printer driver 120 checks a setting status of the print preview flag. When the print preview flag is set to on, the printer driver 120 generates and displays a print preview window on the computer screen (S921, S922, and S923). As illustrated in FIG. 8, when the user wants to print the print document when the print preview window is displayed on the computer screen, the user presses a print button B85 included in the print preview window in FIG. 8 (S924). When the user presses the print button B85 included in the print preview window in FIG. 8, the printer driver 120 generates output data and transmits the output data to the printer 200 for printing (S925 and S926).

Hereinafter, advantages of the method of providing a print preview of a print document according to an exemplary embodiment of the present invention will be described with reference to FIGS. 2 to 8.

First, according to an exemplary embodiment of the present invention, it is unnecessary to predict or inspect a status of a printout of a print object. A user may sufficiently predict or inspect the status of most office documents, such as simple word documents, by previewing layouts of the documents in a print preview window. However, while the user may perform an adjustment, such as a precise color matching operation through the print preview window, it is inefficient and time consuming for the user to confirm the adjustment by repeatedly displaying the print preview window.

Thus, according to an exemplary embodiment of the present invention, it is desirable that when a print button is pressed, a message window is temporarily displayed on a screen to instruct a user to select whether or not to invoke a print preview window, rather than incorporating the print preview function into a user interface of a printer driver. An exemplary embodiment to be described later is related to this fact.

Referring to FIG. 3, according to an exemplary embodiment of the present invention, the message window control module 122 displays a message window as illustrated in FIG. 4B on a screen, when a confirmation button B11 is clicked in a print window as illustrated in FIG. 4A. The message window automatically disappears after the predetermined time period elapses. When the user clicks a confirmation button B13 in the message window, the print preview control module 124 displays a print preview window, as illustrated in FIG. 4C, on the screen. The print preview window displayed by the print preview control module 124 may optionally include an adjustment button B21 for adjusting the print preview. When the adjustment button B21 is clicked, the user may perform an editing operation on the print preview, such as a color matching operation in the print preview window. Additionally, the print preview window displayed by the print preview control module 124 may include a cancel button B17 for canceling the print job of the print document and a skip button B19 for skipping the print preview.

In addition to the above-described print previewing process, the printing process performed after operation S112 in FIG. 2 may include an output data generating process, a half-toning process, a compression process, an emulation process, and the like. That is, the printing process is continued while the message window for the print preview is displayed on the screen.

Therefore, according to the exemplary embodiments of the present invention, it is possible to simplify the construction of the printer driver 120, thereby allowing the user to execute the print preview function without being confused by menus for the print preview function. Additionally, because the print preview function is executed only when the print preview function is activated by a user, it is possible to shorten the whole print output time.

Hereinafter, operations of another exemplary embodiment of the present invention are described with reference to FIGS. 5 to 8.

First, a user executes an application program 110 to open a file for printing (S502) and selects a ‘Print’ menu included in the application program 110 (S504). When the ‘Print’ menu is selected in operation S504, a print window is displayed on the screen (S506).

When the print window is displayed on the screen, the user presses an attribute button to modify an option for the printer driver 120 (S508). In an exemplary embodiment of the present invention, it will be obvious to those skilled in the art that the attribute button may be referred to as registration information or basic settings according to an application program used. When the user presses the attribute button, the registration information window of the printer driver 120 is displayed on the screen, as illustrated in FIG. 8 (S512). The user may input information regarding layout, paper size, and the like in the registration information window illustrated in FIG. 8. In an exemplary embodiment of the present invention, the registration information window refers to a user interface of the printer driver 120.

The user presses the print preview button B83 to preview a print output result based on the input information (S514). When the user presses the print preview button B83 in the registration window, the print preview control module 126 of the printer driver 120 displays a print preview window on the screen (S516), as illustrated in FIG. 8. The user may output the print previewed document by clicking the print button B85 included in the print preview window illustrated in FIG. 8 or cancel the print preview by clicking a cancel button.

Hereinafter, operations of the user interface of the printer driver 120, the automatic selection module 128, and the printer driver 120, performed after the user presses the print preview button B83 are described with reference to FIGS. 6A to 6C.

First, the operation of the user interface of the printer driver 120 is described with reference to FIG. 6A.

When the print preview button B83 is clicked, the print preview control module 126 sets the print preview flag of the printer driver 120 (S901). Thereafter, the print preview control module 126 determines whether the registration information window is invoked by an application program or a control panel (S902). In operation S902, when it is determined that the registration information window is invoked by an application program, the print preview control module 126 activates the automatic selection module 128 (S903), whereas when the registration information window is invoked by the control panel, the print preview control module 126 requests the printer 200 to print a test page (S904).

Next, the operation of the automatic selection module 128 is described with reference to FIG. 6B.

When the automatic selection module 128 is activated by the print preview control module 126, the automatic selection module 128 acquires a handle of the print window that has invoked the registration information window (S911). In an exemplary embodiment of the present invention, it will be obvious to those skilled in the art that the handle is a number unique to a window or a dialog specified by an operating system (that is, an ID of the window or the dialog).

The automatic selection module 128 finds a confirmation button in the print window by means of the handle of the print window (S912). In an exemplary embodiment of the present invention, the confirmation button may be displayed as a print button, an output button, an OK button, or the like, according to an application program used. When the confirmation button is found, the automatic selection module 128 automatically presses the confirmation button to execute the print preview (S913).

Next, the operation of the printer driver 120 is described with reference to FIG. 6C.

When a print request is received, the printer driver 120 checks the setting status of the print preview flag (S921). When the print preview flag is set to on, the printer driver 120 generates and displays the print preview window as illustrated in FIG. 8 on the computer screen (S922 and S923). When the user requests to print the print document when the print preview window is displayed on the computer screen (S924), the printer driver 120 generates output data and transmits the output data to the printer 200 (S925 and S926). In an exemplary embodiment of the present invention, the user may decide whether to print or not to print the print document in the print preview window.

According to the exemplary embodiment of the present invention, it is possible to allow a user to intuitively recognize and execute a print preview function on the user interface of a printer driver. That is, the user may easily select or cancel the print preview function of the printer driver as in a similar manner to the case of using the print preview function supported by an application program.

The exemplary embodiments of the present invention may be written as computer programs and may be implemented in general-use digital computers that execute the programs using a computer readable recording medium. Examples of the computer readable recording medium include magnetic storage media (for example, ROM, floppy discs, hard discs, etc.), optical recording media (for example, CD-ROMs, or DVDS), and storage media such as carrier waves (for example, transmission through the Internet).

According to the present invention, it is possible to allow a user to preview a print document on a user interface (or a registration window) of a printer driver, thereby allowing a user to intuitively recognize a print preview function and execute the print preview function without being confused by menus for the print preview function.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of providing a print preview of a print document, the method comprising:
requesting a print job of the print document;
displaying a print preview selection message window to instruct a user to select whether or not to invoke a print preview window; and
displaying the print preview of the print document when the user invokes the print preview window in the print preview selection message window.

2. The method of claim 1, wherein the print preview selection message window is displayed for a predetermined time period.

3. The method of claim 2, wherein when the predetermined time period elapses, the print document is automatically printed.

4. The method of claim 2, wherein the predetermined time period is substantially equal to the time taken for all print spool data processed by a printer driver to be transmitted to a printer.

5. The method of claim 2, wherein a cancel button for canceling the print preview is included in the print preview selection message window.

6. The method of claim 1, wherein print data is transmitted from a printer driver to a printer during the displaying of the print preview window of the print document.

7. The method of claim 6, wherein a skip button for skipping the print preview is included in the print preview window of the print document.

8. The method of claim 6, wherein a cancel button for canceling the print job of the print document is included in the print preview window of the print document.

9. The method of claim 6, wherein a print adjustment button for adjusting print values for the print document is included in the print preview window of the print document.

10. The method of claim 9, wherein when the print adjustment button is selected, a previous printing process is cancelled and a new printing process reflecting the adjusted print values is started.

11. A method of providing a print preview of a print document, the method comprising:
displaying a printer driver attribute window having a print preview button when an attribute button for modifying a print attribute in a print window is pressed; and
displaying the print preview of the print document on a screen when the print preview button is selected.

12. The method of claim 11, wherein when the print preview button is selected, a confirmation button in the print window is automatically selected to transmit a print command to a printer.

13. The method of claim 12, wherein when the confirmation button in the print window is automatically selected, a setting status of a print preview flag is checked, and the print preview window is displayed.

14. The method of claim 13, wherein a print button for requesting the printer to print the print document is included in the print preview window.

15. A computer readable medium on which a computer-executable program for providing a print preview of a print document is recorded, the computer-executable program comprising instructions for
requesting a print job of the print document;
displaying a print preview selection message window to instruct a user to select whether or not to invoke a print preview window; and
displaying the print preview of the print document when the user invokes the print preview window in the print preview selection message window.

16. The computer readable medium of claim 15, wherein the print preview selection message window is displayed for a predetermined time period.

17. The computer readable medium of claim 16, wherein when the predetermined time period elapses, the print document is automatically printed.

18. The computer readable medium of claim 16, wherein the predetermined time period is substantially equal to the time taken for all print spool data processed by a printer driver to be transmitted to a printer.

19. The computer readable medium of claim 16, wherein a cancel button for canceling the print preview is included in the print preview selection message window.

20. The computer readable medium of claim 15, wherein print data is transmitted from a printer driver to a printer during the displaying of the print preview window of the print document.

21. The computer readable medium of claim 20, wherein a skip button for skipping the print preview is included in the print preview window of the print document.

22. The computer readable medium of claim 20, wherein a cancel button for canceling the print job of the print document is included in the print preview window of the print document.

23. The computer readable medium of claim 20, wherein a print adjustment button for adjusting print values for the print document is included in the print preview window of the print document.

24. A method of providing a print preview of a print document, the method comprising:
selecting a print menu to display a print window;
selecting an attribute button on the print window to display a registration information window;
selecting a print preview button on the registration information window to preview the print output; and
selecting a print button to print or selecting a cancel button to not print the displayed print output.

25. A method of providing a print preview of a print document according to claim 24, further comprising determining whether the registration information window is invoked by an application program or a control panel.

26. A method of providing a print preview of a print document according to claim 25, further comprising opening the automatic selection module when the registration information window is invoked from the application program.

27. A method of providing a print preview of a print document according to claim 25, further comprising printing a test page when the registration information window is invoked from the control panel.

28. A method of providing a print preview of a print document according to claim 26, wherein the automatic selection module automatically selects the print preview button on the registration information window.
